(19) United States
(12) Patent Application Publication
(10) Pub. No.: US 2022/0072937 A1
(43) Pub. Date: Mar. 10, 2022

(54) WEATHER STRIPS HAVING RETENTION FEATURES AND VEHICLES INCORPORATING THE SAME

(71) Applicant: Toyoda Gosei Co., Ltd., Kiyosu-shi (JP)

(72) Inventors: Dominic Black, Southfield, MI (US); Timothy Wilson, Birmingham, MI (US)

(21) Appl. No.: 17/012,529

(22) Filed: Sep. 4, 2020

(51) Int. Cl. B60J 10/84; B60J 10/33; B60J 10/27

(52) U.S. Cl. CPC B60J 10/84; B60J 10/27; B60J 10/33

(57) ABSTRACT

A weather strip is configured to provide a seal between a door and a vehicle component. The weather strip includes a U-shaped retainer portion defining a retainer cavity. The retainer portion having a first inner lip and a second inner lip that extend into the retainer cavity. The first inner lip having a thickness that is less than a thickness of the second inner lip. The second inner lip having a body portion extending outwardly from the retainer portion, a planar end portion extending from the body portion, and a groove formed in a lower surface of the body portion.

### TECHNICAL FIELD

The present specification generally relates to weather strips for a vehicle, and more particularly, weather strips having retention features that retain the weather strips to the vehicle.

### BACKGROUND

It has been known to provide vehicles with weather strips for forming a seal between a portion of the vehicle body and a door of the vehicle. The previously known weather strips include trim portions for receiving a flange of the vehicle body. It has also been known to provide interior fingers inside the trim portion to engage the flange of the vehicle body so as to retain the weather strip to the vehicle. However, the interior fingers increase an insertion force required to insert the flange of the vehicle body in order to install the weather strip to the vehicle.

Accordingly, there is a need for a weather strip for a vehicle that provides sufficient engagement of the weather strip to the vehicle body while reducing an insertion force required to install the weather strip onto the vehicle and increasing an extraction force required to remove the weather strip from the vehicle.

### SUMMARY

In one embodiment, a weather strip provides a seal between a door and a vehicle component. The weather strip includes a U-shaped retainer portion defining a retainer cavity. The retainer portion having a first inner lip and a second inner lip that extend into the retainer cavity. The first inner lip having a thickness that is less than a thickness of the second inner lip. The second inner lip having a body portion extending outwardly from the retainer portion, a planar end portion extending from the body portion, and a groove formed in a lower surface of the body portion.

In another embodiment, a vehicle includes a vehicle body, a door, and a weather strip. The weather strip is configured to provide a seal between the door and the vehicle body. The weather strip includes a U-shaped retainer portion defining a retainer cavity. The retainer portion having a first inner lip and a second inner lip that extend into the retainer cavity. The first inner lip having a thickness that is less than a thickness of the second inner lip. The second inner lip having a body portion extending outwardly from the retainer portion, a planar end portion extending from the body portion, and a groove formed in a lower surface of the body portion.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a side view of a vehicle including a door and a weather strip according to one or more embodiments shown or described herein;

FIG. 2 schematically depicts a side view of the weather strip of FIG. 1 according to one or more embodiments shown or described herein.

FIG. 3 is a partial isolated cross-sectional view of the weather strip taken along line A-A of FIG. 1, according to one or more embodiments shown or described herein;

FIG. 4A schematically depicts a partial cross-sectional view of the door assembly taken along the line A-A of FIG. 1, in which the weather strip is in an installed state; and

FIG. 4B schematically depicts a partial cross-sectional view of the door assembly taken along the line A-A of FIG. 1, in which the weather strip is moved from the installed position towards an uninstalled position.

### DETAILED DESCRIPTION

Vehicles according to the present specification include a door, a vehicle body component, and a weather strip. The weather strip is configured to provide a seal between the door and the vehicle body component in order to inhibit the ingress of an external vehicle environment to an internal vehicle environment.

The weather strip includes a retainer portion defining a retainer cavity, the U-shaped retainer portion having a first inner lip and a second inner lip that extend into the retainer cavity, the first inner lip having a thickness that is less than a thickness of the second inner lip, the second inner lip having a body portion extending outwardly from the retainer portion, a planar end portion extending from the body portion, and a groove formed in a lower surface of the body portion. As such, an insertion force required to insert a flange of a vehicle body component into the retainer cavity of the retainer portion is reduced due to the thickness of the first inner lip. Further, the insertion force required to insert the flange of the vehicle body component into the retainer cavity of the retainer portion is reduced due to the groove formed on the lower surface of the second inner lip.

The weather strips according to the present specification also provide an engagement between the second inner lip and the flange of the vehicle body component such that an extraction force required to extract the flange of the vehicle body component from the retainer portion is increased to avoid unintended removal of the weather strip from the vehicle. Specifically, the planar end portion of the second inner lip provides an increase in contact area between the second inner lip and the flange upon movement of the flange from an installed state towards an uninstalled state.

Various embodiments of the vehicles and weather strips are described in detail below with reference to the appended drawings.

As used herein, the term “vehicle longitudinal direction” refers to the forward-rearward direction of the vehicle (i.e., in the +/−vehicle X-direction as depicted). The term “vehicle lateral direction” refers to the cross-vehicle direction of the vehicle (i.e., in the +/−vehicle Z-direction as depicted), and is transverse to the vehicle longitudinal direction. The term “vehicle vertical direction” refers to the upward-downward direction of the vehicle (i.e., in the +/−vehicle Y-direction as depicted). As used herein, “upper” and “above” are defined as the positive Y direction of the coordinate axis shown in the drawings. “Lower” and “below” are defined as the negative Y direction of the coordinate axis shown in the drawings. Further, the terms “outboard” as used herein refers to the relative location of a component with respect to a vehicle centerline. The term “inboard” as used herein refers to the relative location of a component with respect to the vehicle centerline. Because the vehicle structures may be generally symmetrical about the vehicle centerline, the direction to which use of terms “inboard” or “outboard” and refer may be mirrored about the vehicle centerline when evaluating components positioned along opposite sides.

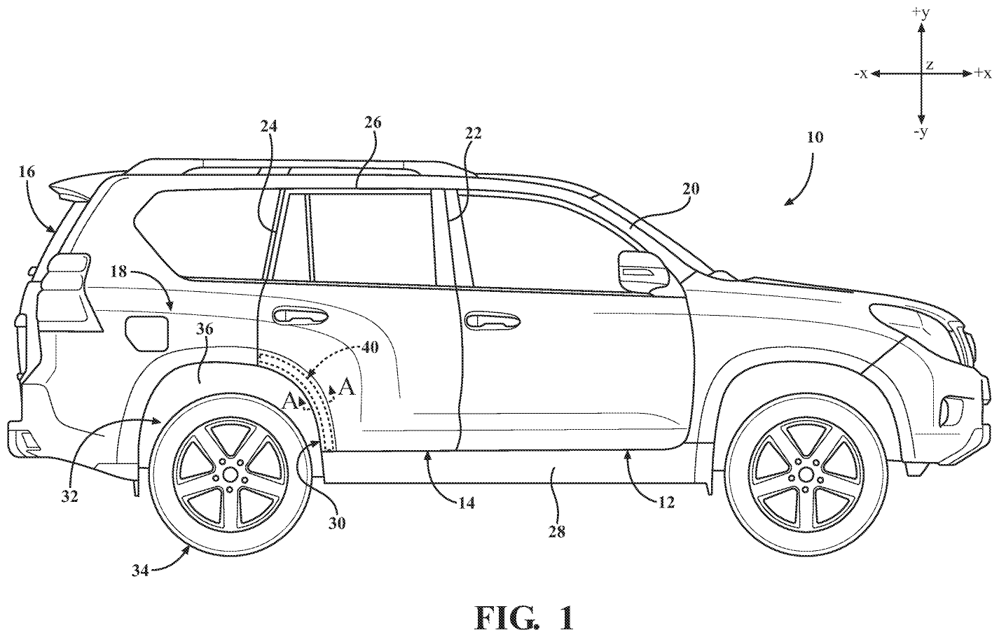

Referring to FIG. 1, a vehicle 10 is depicted. The vehicle 10 includes a front door 12, a rear door 14, and a cargo door 16. The front door 12, the rear door 14, and the cargo door 16 are hingedly coupled to a vehicle body 18. The front door 12 is coupled to an A-pillar structure 20, the rear door 14 is coupled to a B-pillar structure 22, and the cargo door 16 is coupled to a rear portion of the vehicle body 18. In some embodiments, the front door 12 is hingedly coupled to the A-pillar structure 20, the rear door 14 is hingedly coupled to the B-pillar structure 22, and the cargo door 16 is hingeldy coupled to the rear portion of the vehicle body 18. In other embodiments, the rear door 14 may be severally coupled to the B-pillar structure 22, such as when the rear door 14 is sliding door or when the rear door 14 is hingedly coupled to a C-pillar structure (i.e., a rear-hinged door).

The vehicle body 18 includes a rear door opening portion 26 that extends between the B-pillar structure 22 and the C-pillar structure 24. The rear door opening portion 26 includes a C-pillar margin structure 30 that extends between the C-pillar structure 24 and a rocker 28 of the vehicle body 18. The C-pillar margin structure 30 is provided adjacent a wheel well 32 of the vehicle 10. The wheel well 32 is configured to receive a wheel 34 and includes a wheel well liner 36 that separates the wheel well 32 from the vehicle body 18.

A weather strip 40 is provided along the C-pillar margin structure 30 to form a seal between the rear door 14 and the C-pillar margin structure 30 to inhibit the ingress of an external vehicle environment into an internal vehicle environment. As shown in FIG. 1, the weather strip 40 extends along the C-pillar margin structure 30 between a bottom end of the C-pillar structure 24 and the rocker 28.

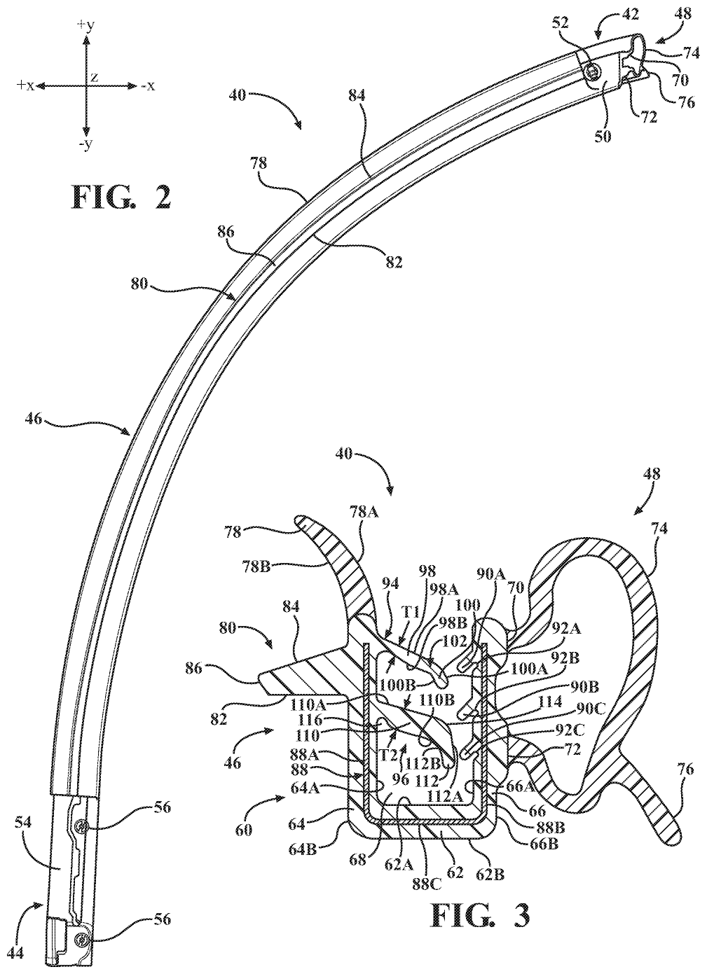

Referring to FIG. 2, the weather strip 40 includes an upper attachment portion 42, a lower attachment portion 44, and an intermediate attachment portion 46. The intermediate attachment portion 46 extends between the upper attachment portion 42 and the lower attachment portion 44. As will be described in greater detail below, a tubular seal member 48 extends from the upper attachment portion 42 to the lower attachment portion 44.

The upper attachment portion 42 includes an upper attachment wall 50. The upper attachment wall 50 includes at least one upper fastener 52. The upper fastener 52 extends from the upper attachment wall 50 on a side opposite from the tubular seal member 48. The upper fastener 52 is configured to couple the upper attachment portion 42 to the C-pillar margin structure 30 of the vehicle body 18.

The lower attachment portion 44 includes a lower attachment wall 54. The lower attachment wall 54 includes at least one lower fastener 56. The lower fastener 56 extends from the lower attachment wall 54 on a side opposite from the tubular seal member 48. The lower fastener 56 is configured to couple the lower attachment portion 44 to the C-pillar margin structure 30 of the vehicle body 18.

The upper fastener 52 and the lower fastener 56 may be in the form of a clip, screw, bolt, adhesive, or any other fastener configured to connected one member to another member. It is appreciated, that the upper fastener 52 may engage with an upper opening formed in the C-pillar margin structure 30 and the lower fastener 56 may engage with a lower opening formed in the C-pillar margin structure 30. The engagement of the upper fastener 52 with the upper opening and the lower fastener 56 with the lower opening secures the upper attachment portion 42 and the lower attachment portion 44, respectively, to the C-pillar margin structure 30.

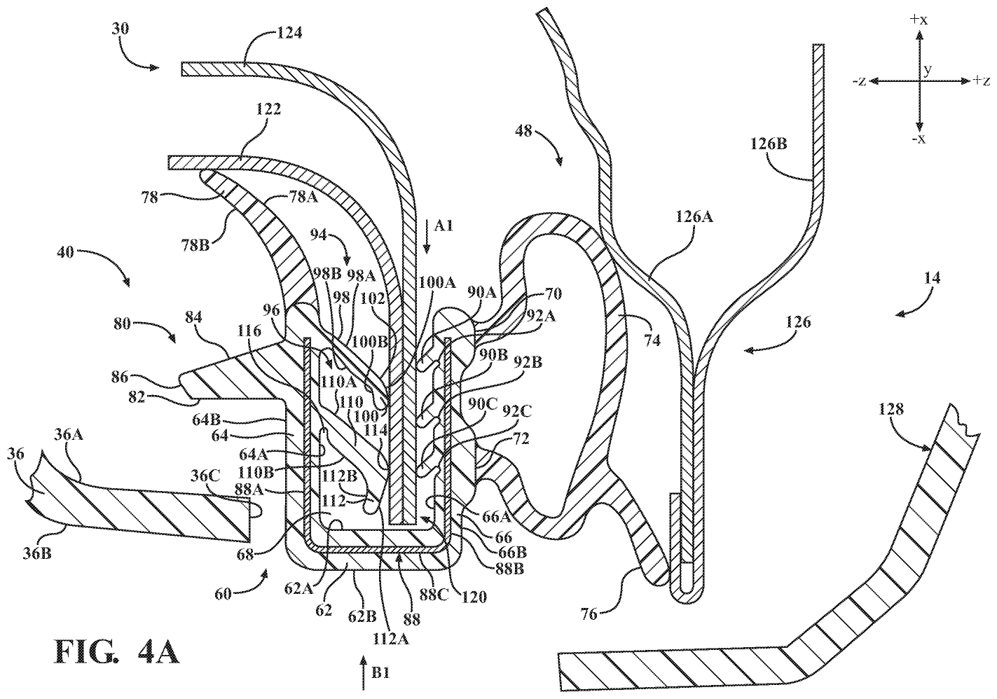

Referring to FIGS. 2 and 3, the intermediate attachment portion 46 extends between the upper attachment wall 50 and the lower attachment wall 54. The intermediate attachment portion 46 includes a generally U-shaped retainer portion 60. The retainer portion 60 includes a base wall 62, an inner wall 64, and an opposite outer wall 66. The inner wall 64 and the outer wall 66 extend outwardly from the base wall 62 to define a retainer cavity 68. The base wall 62 includes an interior surface 62A and an opposite exterior surface 62B. The inner wall 64 includes an interior surface 64A and an opposite exterior surface 64B. The outer wall 66 includes an interior surface 66A and an opposite exterior surface 66B. The interior surface 64A of the inner wall 64 faces the interior surface 66A of the outer wall 66. The interior surface 62A of the base wall 62, the interior surface 64A of the inner wall 64, and the interior surface 66A of the outer wall 66 define the retainer cavity 68.

The tubular seal member 48 is coupled to the exterior surface 66B of the outer wall 66 of the retainer portion 60. The exterior surface 66B of the outer wall 66 includes an upper connection portion 70 and a lower connection portion 72. The upper connection portion 70 and the lower connection portion 72 connect to ends of a seal wall 74 to form a generally tubular seal that extends along the weather strip 40 from the upper attachment portion 42 to the lower attachment portion 44. A seal finger 76 extends outwardly from the seal wall 74.

The retainer portion 60 may also include an extension 78 that extends generally outwardly from an upper end of the inner wall 64. The extension 78 includes an inner surface 78A and an opposite outer surface 78B. The inner surface 78A of the extension 78 may extend from the interior surface 64A of the inner wall 64. The outer surface 78B of the extension 78 may extend from the exterior surface 64B of the inner wall 64.

The retainer portion 60 may also include a projection 80 that extends generally outwardly from the exterior surface 64B of the inner wall 64. The retainer portion 60 is provided with the tubular seal member 48 on the exterior surface 66B of the outer wall 66 and the projection 80 on the exterior surface 64B of the inner wall 64. The projection 80 includes a generally planar contact surface 82 and an opposite tapered surface 84. The contact surface 82 and the tapered surface 84 extends outwardly from the exterior surface 64B of the inner wall. The projection 80 includes a distal end 86 that is spaced apart from the exterior surface 64B of the inner wall 64 by a predetermined distance. A distance between the contact surface 82 and the tapered surface 84 adjacent the exterior surface 64B of the inner wall 64 is greater than a distance between the contact surface 82 and the tapered surface 84 adjacent the distal end 86 as the tapered surface 84 is inclined so as to narrow along the projection 80 from the exterior surface 64B of the inner wall 64 towards the distal end 86. The distal end 86 may be chamfered such that a distance from the distal end 86 adjacent the contact surface 82 to the exterior surface 64B of the inner wall 64 is less than a distance from the distal end 86 adjacent the tapered surface 84 to the exterior surface 64B of the inner wall 64.

The retainer portion 60 may also include a generally U-shaped reinforcement member 88. The reinforcement member 88 is embedded within the retainer portion 60. The reinforcement member 88 includes an inner wall 88A, an outer wall 88B, and a base wall 88C. The inner wall 88A and the outer wall 88B extend outwardly from the base wall 88C. The inner wall 88A of the reinforcement member 88 is embedded between the interior surface 64A and the exterior surface 64B of the inner wall 64 of the retainer portion 60. The outer wall 88B of the reinforcement member 88 is embedded between the interior surface 66A and the exterior surface 66B of the outer wall 66 of the retainer portion 60. The base wall 88C of the reinforcement member 88 is embedded between the interior surface 62A and the exterior surface 62B of the base wall 62 of the retainer portion 60.

In some embodiments, the weather strip 40 including the tubular seal member 48, the retainer portion 60, the extension 78, and the projection 80 may be formed from a variety of natural or synthetic materials, illustratively including an elastomer or a thermoplastic elastomer (TPE) such as thermoplastic vulcanisate (TPV). TPV materials may give consistent and predictable performance, extended durability, and light and moisture resistance. The reinforcement member 88 may be formed of a material having a higher rigidity than the material forming the retainer portion 60 of the weather strip 40. In some embodiments, the reinforcement member 88 may be formed of a metallic, metal alloy, natural or synthetic resin material, and fiber reinforced resin material. By forming the reinforcement member 88 of a material having a higher rigidity than the material forming the retainer portion 60, the reinforcement member 88 reinforces the retainer portion 60 such that the retainer portion 60 retains the generally U-shape.

The retainer portion 60 is also provided with a retention feature configured to retain the retainer portion 60 to the door opening portion 26 of the vehicle body 18. The retention features includes an upper lip 90A, a middle lip 90B, and a lower lip 90C that extend from the interior surface 66A of the outer wall 66. As discussed in greater detail below, the upper lip 90A, the middle lip 90B, and the lower lip 90C are configured to retain the door opening portion 26 of the vehicle body 18 within the retainer cavity 68 of the retainer portion 60.

The upper lip 90A, the middle lip 90B, and the lower lip 90C are provided on the interior surface 66A of the outer wall 66 opposite the tubular seal member 48. The upper lip 90A is positioned closer to an opening of the retainer cavity 68 than the lower lip 90C. The lower lip 90C is positioned closer to the base wall 62 of the retainer portion 60 than the upper lip 90A. The middle lip 90B is positioned between the upper lip 90A and the lower lip 90C.

The upper lip 90A includes an upper recess 92A positioned at a junction of a lower surface of the upper lip 90A and the interior surface 66A of the outer wall 66. The middle lip 90B includes a middle recess 92B positioned at a junction of a lower surface of the middle lip 90B and the interior surface 66A of the outer wall 66. The lower lip 90C includes a lower recess 92C positioned at a junction of a lower surface of the lower lip 90C and the interior surface 66A of the outer wall 66. The upper recess 92A, the middle recess 92B, and the lower recess 92C are recessed with respect to the interior surface 66A of the outer wall 66. The upper recess 92A, the middle recess 92B, and the lower recess 92C reduces a force required to move the upper lip 90A, the middle lip 90B, and the lower lip 90C, respectively, towards the base wall 62 of the retainer portion 60.

As such, an insertion force of the door opening portion 26 of the vehicle body 18 into the retainer cavity 68 is reduced. However, as the upper recess 92A, the middle recess 92B, and the lower recess 92C are formed at an junction of the interior surface 66A of the outer wall 66 and the lower surfaces of the upper lip 90A, the middle lip 90B, and the lower lip 90C, a force required to move the upper lip 90A, the middle lip 90B, and the lower lip 90C towards the opening of the retainer cavity 68 is maintained. As such, the upper recess 92A, the middle recess 92B, and the lower recess 92C lower reduces an insertion force of the door opening portion 26 into the retainer cavity 68 is reduced while maintaining an extraction force of the door opening portion 26 out of the retainer cavity 68.

The retainer portion 60 is also provided with another retention feature configured to retain the retainer portion 60 to the door opening portion 26 of the vehicle body 18. The retention feature includes a first inner lip 94 and a second inner lip 96. As discussed in greater detail below, the first inner lip 94 and the second inner lip 96 in conjunction with the upper lip 90A, the middle lip 90B, and the lower lip 90C, are configured to retain the door opening portion 26 of the vehicle body 18 within the retainer cavity 68 of the retainer portion 60.

The first inner lip 94 and the second inner lip 96 are provided on the interior surface 64A of the inner wall opposite the projection 80. The first inner lip 94 is positioned closer to the opening of the retainer cavity 68 than the second inner lip 96. The second inner lip 96 is positioned closer to the base wall 62 of the retainer portion 60 than the first inner lip 94.

The first inner lip 94 includes a first main body portion 98 and a first end portion 100. The first main body portion 98 extends outwardly from the interior surface 64A of the inner wall 64. The first end portion 100 is formed as a distal end of the first inner lip 94. The first main body portion 98 transitions to the first end portion 100 at a first junction 102.

The first main body portion 98 includes an upper surface 98A and an opposite lower surface 98B. The first main body portion 98 includes a first thickness T1 that extends between the upper surface 98A and the lower surface 98B. In some embodiments, the first main body portion 98 is formed having a generally uniform first thickness T1 extending from the interior surface 64A to the first junction 102. In some other embodiments, the first main body portion 98 is formed having a varying thickness extending from the interior surface 64A to the first junction 102. In such an embodiment, the first thickness T1 may be the largest thickness between the upper surface 98A and the lower surface 98B of the first main body portion 98.

The first thickness T1 of the first main body portion 98 is less than the second thickness T2 of the second main body portion 110. In some embodiments, the first thickness T1 of the first main body portion 98 is at least half of the second thickness T2 of the second main body portion 110. It is appreciated that the first thickness T1 of the first main body portion 98 may be at least less than half the second thickness T2 of the second main body portion 110, for example 49%, 45%, 40% of the second thickness T2 of the second main body portion 110.

The first end portion 100 is formed having a bulbous shape. The first end portion 100 includes an upper surface 100A and an opposite lower surface 100B. In some embodiments, the first end portion 100 is angled with respect to the first main body portion 98. Specifically, the lower surface 100B of the first end portion 100 forms an obtuse angle with the lower surface 98B of the first main body portion 98.

The second inner lip 96 includes a second main body portion 110 and a second end portion 112. The second main body portion 110 extends outwardly from the interior surface 64A of the inner wall 64. The second end portion 112 is formed as a distal end of the second inner lip 96. The second main body portion 110 transitions to the second end portion 112 at a second junction 114. The second end portion 112 is formed as a planar end portion.

The second main body portion 110 includes an upper surface 110A and an opposite lower surface 110B. The second main body portion 110 includes a second thickness T2 that extends between the upper surface 110A and the lower surface 110B. In some embodiments, the second main body portion 110 is formed having a generally uniform second thickness T2 extending from the interior surface 64A to the second junction 114. In some other embodiments, the second main body portion 110 is formed having a varying thickness extending from the interior surface 64A to the second junction 114. In such an embodiment, the second thickness T2 may be the largest thickness between the upper surface 110A and the lower surface 110B of the second main body portion 110.

The second end portion 112 includes an upper surface 112A and an opposite lower surface 112B. In some embodiments, the second end portion 112 is angled with respect to the second main body portion 110. Specifically, the lower surface 112B of the second end portion 112 forms an obtuse angle with the lower surface 110B of the second main body portion 110. The upper surface 112A of the second end portion 112 is formed as a generally planar (i.e. flat) surface. The second junction 114 is formed as a generally arcuate or curved surface that transitions the upper surface 110A of the second main body portion 110 to the upper surface 112A of the second end portion 112.

The second main body portion 110 includes a groove 116 at a junction of the lower surface 110B of the second main body portion 110 and the interior surface 64A of the inner wall 64. The groove 116 is formed so as to be recessed with respect to one or both of the lower surface 110B of the second main body portion 110 and/or the interior surface 64A of the inner wall 64. In the illustrated embodiment, the groove 116 is formed as a generally semicircular notch or cutout extending along a length of the second main body portion 110 from the lower surface 110B of the second main body portion 110. It is appreciated that the groove 116 may be formed having other shapes, such as a V-shape or a U-shape.

The groove reduces a force required to move the second inner lip towards the base wall 62 of the retainer portion 60. As such, an insertion force of the door opening portion 26 of the vehicle body 18 into the retainer cavity 68 is reduced. However, as the groove 116 is formed at a junction of the interior surface 64A of the inner wall 64 and the lower surface 110B of the second main body portion 110, a force required to move the second inner lip 96 towards the opening of the retainer cavity 68 is maintained. As such, the groove 116 reduces an insertion force of the door opening portion 26 into the retainer cavity 68 while maintaining an extraction force of the door opening portion 26 out of the retainer cavity 68.

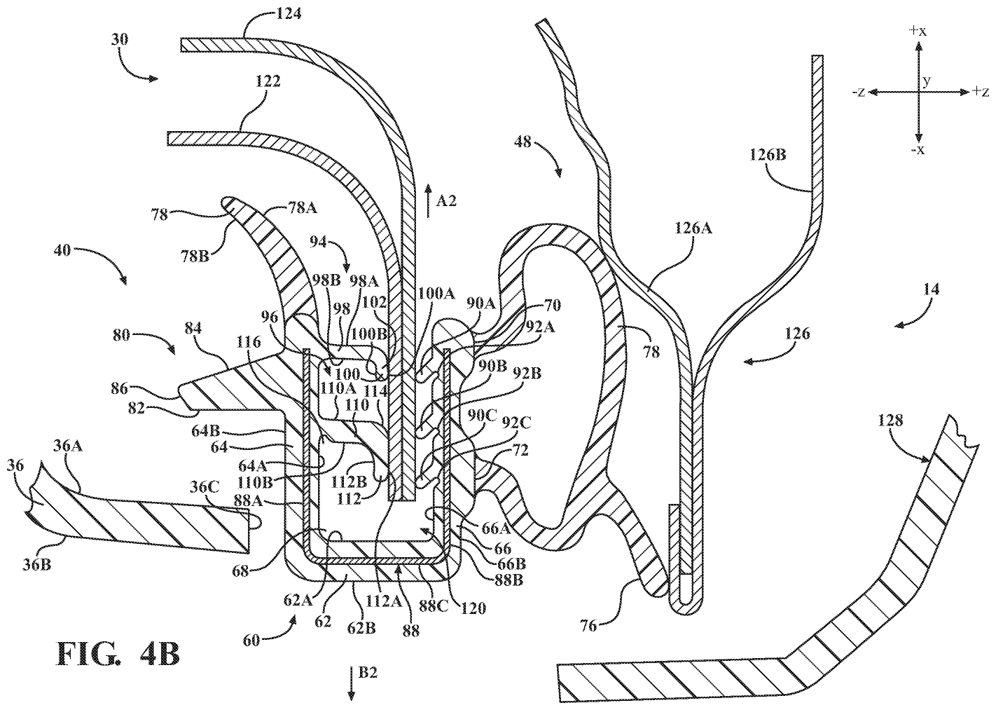

Referring to FIG. 4A, the weather strip 40 is illustrated in an installed state in which a portion of the vehicle body 18 is received within the retainer cavity 68 of the retainer portion 60. As discussed above, the weather strip 40 is installed at a door opening portion 26 of the C-pillar margin structure 30 of the vehicle body 18. The door opening portion 26 of the C-pillar margin structure 30 constitutes a vehicle body component that includes a flange 120. The flange 120 of the vehicle body component includes an inner flange 122 and an outer flange 124 that are fixed together.

In the installed position, the weather strip 40 is configured to form a seal between the vehicle body 18 and the rear door 14. As shown in FIG. 4A, the rear door 14 may include a door panel 126 and a door garnish 128. The door panel 126 includes an inner door panel 126A and an outer door panel 126B that are fixed together. The tubular seal member 48 is configured to deform in order to form a seal between the rear door 14 and the vehicle body 18, specifically, the C-pillar margin 30 of the door opening portion 26 that constitutes the vehicle body component. The seal finger 76 is configured to contact the rear door 14, specifically, the door panel 126, in order to inhibit the ingress of the external vehicle environment. As such, the tubular seal member 48 provides a double layer of sealing with the rear door 14 due to the contact between the seal finger 76 and the seal wall 74 with the door panel 126.

In the installed state, the projection 80 is provided so as to face an interior surface 36A of the wheel well liner 36. The interior surface 36A of the wheel well liner 36 is opposite the exterior surface 36B of the wheel well liner 36. Specifically, the interior surface 36A of the wheel well liner 36 faces the contact surface 82 of the projection 80. The projection 80 is positioned such that the distal end 86 extends beyond a gap formed between an edge 36C of the wheel well liner 36 and the exterior surface 64B of the inner wall 64 of the retainer portion 60. Specifically, the predetermined distance of the projection 80 is formed to be greater than the distance between the edge 36C of the wheel well liner 36 and the exterior surface 64B of the inner wall 64 of the retainer portion 60. As such, the contact surface 82 of the projection 80 is configured to contact the interior surface 36A of the wheel well liner 36 to inhibit the disengagement of the weather strip 40 from the vehicle body 18.

In the installed state, the extension 78 is configured to contact a portion of the inner flange 122. The contact between the extension 78 and the inner flange 122 creates a seal to inhibit the ingress of the external vehicle environment into the retainer cavity 68.

In the installed state, the flange 120 is received within and engaged by the retention features of the retainer portion 60. Specifically, the outer flange 124 is engaged by the upper lip 90A, the middle lip 90B, and the lower lip 90C, and the inner flange 122 is engaged by the first inner lip 94 and the second inner lip 96. The engagement of the flange 120 by the upper lip 90A, the middle lip 90B, and the lower lip 90C on one side and the first inner lip 94 and the second inner lip 96 on an opposite side allows for the flange 120 to be secured irrespective of variations in a thickness of the flange 120.

As described above, an insertion force, in an installation direction, required to insert the flange 120 within the retainer cavity 68 is reduced by the upper recess 92A, the middle recess 92B, and the lower recess 92C, the formation of the first inner lip 94 having the thickness T1 of the first main body portion 98 that is at least half or less of the thickness T2 of the second main body portion 110, and the formation of the groove 116 at the junction of the lower surface 112B of the second main body portion 110 and the interior surface 64A of the inner wall 64. In some embodiments, the flange 120 is coupled to the weather strip 40 by inserting the flange 120 in a flange installation direction A1 in which the flange 120 is inserted into the retainer cavity 68 of the retainer portion 60. In some other embodiments, the weather strip 40 is coupled to the flange 120 by moving the weather strip 40 in a weather strip installation direction B1. As such, the installation direction may include the flange installation direction A1, the weather strip installation direction B1, or both the flange installation direction A1, the weather strip installation direction B1.

Due to the thickness T1 of the first main body portion 98 being at least half or less of the thickness T2 of the second main body portion 110, the insertion force required to bend the first inner lip 94 downwardly towards the base wall 62 of the retainer portion 60 is reduced. Further, due to the thickness T1 of the first main body portion 98, the inner wall 64, and the outer wall 66 of the retainer portion 60 are inhibited from spreading apart during the insertion of the flange 120.

In the installed state, the upper surface 100A of the first end portion 100 contacts the inner flange 122 of the flange 120. Specifically, the upper surface 100A of the first end portion 100 between the first junction 102 and the distal end of the first end portion 100 contacts the inner flange 122 of the flange 120.

Due to the groove 116 formed at the junction of the lower surface 110B of the second main body portion 110 and the interior surface 64A of the inner wall 64, the insertion force required to bend the second inner lip 96 downwardly towards the base wall 62 of the retainer portion 60 is reduced. Further, as the second junction 114 is formed at the connection of the convergence of the second main body portion 110 and the second end portion 112, the second junction 114 is formed having a curved or arcuate shape. As such, a contact area between the second junction 114 of the second inner lip and the inner flange 122 of the flange 120 in the installed state is a first contact area.

During the installation of the flange 120 into the retainer cavity 68, the flange 120 contacts the upper surface 110A of the second main body portion 110 and the second junction 114. In some embodiments, the flange 120 does not contact the upper surface 112A of the second end portion 112 during the movement of the flange 120 from an uninstalled state to the installed state. In the uninstalled state, the flange 120 is spaced apart from the retainer cavity 68. In the installed state, the flange 120 is retained within the retainer cavity 68 due to a friction force applied to the flange 120 by the upper lip 90A, the middle lip 90B, the lower lip 90C, the first inner lip 94, and the second inner lip 96.

Referring to FIG. 4B, the weather strip 40 is illustrated in a state in which the weather strip 40 is moved from the installed state towards an uninstalled state. In the uninstalled state, the flange 120 is removed and spaced apart from the retainer cavity 68 of the retainer portion 60. Upon movement of the flange 120 in a withdrawal direction, in an extraction force required to extract or uninstall the flange 120 from the retainer portion 60 is increased due to the shape of the second inner lip 96. In some embodiments, the flange 120 is removed from the weather strip 40 by withdrawing the flange 120 in a flange withdrawal direction A2 in which the flange 120 is removed from the retainer cavity 68 of the retainer portion 60. In some other embodiments, the weather strip 40 is removed from the flange 120 by moving the weather strip 40 in a weather strip withdrawal direction B2. As such, the withdrawal direction may include the flange withdrawal direction A2, the weather strip withdrawal direction B2, or both the flange withdrawal direction A2, the weather strip withdrawal direction B2.

As shown in FIG. 4B, as the flange 120 is moved in the withdraw direction A2, the second inner lip 96 is bent upwards towards the opening of the retainer cavity 68 such that the upper surface 112A of the second end portion 112 contacts the inner flange 122 of the flange 120. As the upper surface 112A of the second end portion 112 is formed as a general planar and flat surface, a contact area between the upper surface 112A and the inner flange 122 of the flange in the state moving from the installed state towards the uninstalled state is a second contact area. The second contact area is larger than the first contact area. As the second contact area is larger than the first contact area the extraction force required to withdraw the flange 120 from the retainer cavity 68 is increased.

Still referring to FIG. 4B, as the distal end 86 of the projection 80 extends beyond the gap formed between the edge 36C of the wheel well liner 36 and the exterior surface 64B of the inner wall 64, the contact surface 82 of the projection 80 is configured to contact the interior surface 36A of the wheel well liner 36 to inhibit the detachment of the weather strip 40 from the flange 120 of the vehicle body 18. Specifically, upon continued movement of the weather strip 40 in the weather strip withdrawal direction B2, the contact surface 82 of the projection 80 contacts the interior surface 36A of the wheel well liner 36 to increase the extraction force required to remove the weather strip 40 from the flange 120 of the vehicle body 18. In some embodiments, the projection 80 is positioned on the exterior surface 64A of the inner wall 64 between the first inner lip 94 and the second inner lip 96. It is appreciated that the projection 80 may be positioned at other positions on the exterior surface 64B of the inner wall 64. In some embodiments, the projection 80 may be positioned on the exterior surface 64B of the inner wall 64 such that the contact surface 82 contacts the interior surface 36A of the wheel well liner 36 while the flange 120 is still engaged with at least one of the first inner lip 94 and the second inner lip 96 as the weather strip 40 is removed in the weather strip withdrawal direction B2.

In some embodiments, the weather strip 40 is provided at a portion of the rear door 14. However, the weather strip 40 is not limited to use with the rear door 14 and may be utilized with the front door 12 or the cargo door 16 of the vehicle 10. In some embodiments, the vehicle 10 is a car. In some other embodiments, the vehicle 10 may be a truck, a sport utility vehicle, a van, a boat, a plane, or other vehicle types.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It is claimed:

1. A weather strip for providing a seal between a door and a vehicle component, the weather strip comprising:
a U-shaped retainer portion defining a retainer cavity, retainer portion having a first inner lip and a second inner lip that extend into the retainer cavity, the first inner lip having a thickness that is less than a thickness of the second inner lip, the second inner lip having a body portion extending outwardly from the retainer portion, a planar end portion extending from the body portion, and a groove formed in a lower surface of the body portion.

2. The weather strip according to claim 1, wherein the retainer portion includes an inner wall, an outer wall, and an outwardly extending projection positioned on an exterior surface of the inner wall.

3. The weather strip according to claim 2, wherein the outwardly extending projection is positioned on the inner wall between the first inner lip and the second inner lip.

4. The weather strip according to claim 1, wherein the retainer portion includes an inner wall, an opposite outer wall, and a base wall, the inner wall and the outer wall extends outwardly from the base wall to define the retainer cavity, the inner wall includes an interior surface and an opposite exterior surface, the outer wall includes an interior surface and an opposite exterior surface, the interior surface of the inner wall faces the interior surface of the outer wall, the first inner lip and the second inner lip extend from the interior surface of the inner wall.

5. The weather strip according to claim 4, wherein the groove is formed at a junction of the lower surface of the body portion of the second inner lip and the interior surface of the inner wall.

6. The weather strip according to claim 5, wherein the second inner lip is positioned closer to the base wall than the first inner lip.

7. The weather strip according to claim 6, wherein the body portion of the second inner lip includes an upper surface opposite the lower surface, the end portion of the second inner lip includes an exterior surface and an opposite interior surface, the lower surface of the body portion and the interior surface of the end portion forms an acute angle.

8. The weather strip according to claim 1, wherein the thickness of the first inner lip is between an upper surface and an opposite lower surface of the first inner lip and the thickness of the second inner lip extends between the lower surface of the body portion of the second inner lip and an opposite upper surface of the body portion of the second inner lip,
wherein the thickness of the first inner lip is less than half of the thickness of the second inner lip.

9. The weather strip according to claim 1, wherein a flange of the vehicle component is configured to be inserted within the retainer cavity of the retainer portion such that a junction between the body portion of the second inner lip and the end portion of the second inner lip contacts the flange.

10. The weather strip according to claim 9, wherein upon movement of the flange of the vehicle component in a removal direction, the second inner lip bends such that an exterior surface of the planar end portion contacts the flange.

11. A vehicle comprising:
a vehicle body;
a door; and
a weather strip configured to provide a seal between the door and the vehicle body, the weather strip includes a U-shaped retainer portion defining a retainer cavity, the retainer portion having a first inner lip and a second inner lip that extend into the retainer cavity, the first inner lip having a thickness that is less than a thickness of the second inner lip, the second inner lip having a body portion extending outwardly from the retainer portion, a planar end portion extending from the body portion, and a groove formed in a lower surface of the body portion.

12. The vehicle according to claim 11 further comprising a vehicle body component,
wherein the retainer portion includes an inner wall, an outer wall, and an outwardly extending projection positioned on an exterior surface of the inner wall, and
wherein the projection is configured to contact the vehicle body component to inhibit the weather strip from detaching from the vehicle body.

13. The vehicle according to claim 12, wherein the retainer portion includes an inner wall, an opposite outer wall, and a base wall, the inner wall and the outer wall extends outwardly from the base wall to define the retainer cavity, the inner wall includes an interior surface and an opposite exterior surface, the first inner lip and the second inner lip extend from the interior surface of the inner wall and the projection extends from the exterior surface of the inner wall.

14. The vehicle according to claim 11, wherein the retainer portion includes an inner wall, an opposite outer wall, and a base wall, the inner wall and the outer wall extends outwardly from the base wall to define the retainer cavity, the inner wall includes an interior surface and an opposite exterior surface, the outer wall includes an interior surface and an opposite exterior surface, the interior surface of the inner wall faces the interior surface of the outer wall, the first inner lip and the second inner lip extend from the interior surface of the inner wall.

15. The vehicle according to claim 14, wherein the groove is formed at a junction of the lower surface of the body portion of the second inner lip and the interior surface of the inner wall.

16. The vehicle according to claim 15, wherein the second inner lip is positioned closer to the base wall than the first inner lip.

17. The vehicle according to claim 16, wherein the body portion of the second inner lip includes an upper surface opposite the lower surface, the end portion of the second inner lip includes an exterior surface and an opposite interior surface, the lower surface of the body portion and the interior surface of the end portion forms an acute angle.

18. The vehicle according to claim 11, wherein the thickness of the first inner lip is between an upper surface and an opposite lower surface of the first inner lip and the thickness of the second inner lip extends between the lower surface of the body portion of the second inner lip and an opposite upper surface of the body portion of the second inner lip,
wherein the thickness of the first inner lip is less than half of the thickness of the second inner lip.

19. The vehicle according to claim 11, wherein a flange of the vehicle body is configured to be inserted within the retainer cavity of the retainer portion such that a junction between the body portion of the second inner lip and the end portion of the second inner lip contacts the flange.

20. The vehicle according to claim 19, wherein upon movement of the flange of the vehicle body in a removal direction, the second inner lip bends such that an exterior surface of the planar end portion contacts the flange.
